(19) United States
(12) Patent Application Publication
(10) Pub. No.: US 2025/0291846 A1
(43) Pub. Date: Sep. 18, 2025

(54) SYSTEMS AND METHODS TO GENERATE NARRATIVES BASED ON A COMPREHENSIVE SET OF EXPERIENCES OF USERS

(71) Applicant: Disney Enterprises, Inc., BURBANK, CA (US)

(72) Inventors: Alif Khalfan, Redwood City, CA (US); Malcolm E. Murdock, Burbank, CA (US)

(21) Appl. No.: 18/603,698

(22) Filed: Mar. 13, 2024

(51) Int. Cl. G06F 16/738; G06F 16/783; G06F 16/787; G06V 20/40

(52) U.S. Cl. CPC G06F 16/739; G06F 16/7837; G06F 16/787; G06V 20/40; G06V 2201/10

(57) ABSTRACT

Systems and methods to generate narratives based on a comprehensive set of experiences of users are disclosed. Exemplary implementations may: receive user authorization to obtain, from information sources, pieces of information that define transportation and/or occurrences of a user that comprise an adventure of the user; determine, based on the pieces of information, aspect values that define the aspects of the transportation and the aspects of the occurrences; input the aspect values that define the aspects of the transportation and the aspects of the occurrences to the content generation model so that the content generation model determines the adventure of the user and generates, based on the aspect values, a narrative that features the aspects of the occurrences and one or more aspects of the transportation to represent the adventure of the user; obtain, from the content generation model, the narrative; and effectuate presentation of the narrative to the user.

### FIELD OF THE DISCLOSURE

The present disclosure relates to systems and methods to generate narratives based on a comprehensive set of experiences of users.

### BACKGROUND

As individuals plan and embark on adventures, the individuals may participate in multiple occurrences that involve one or more content domains. Such individuals may manually generate content to memorialize their adventures as keepsakes or to share. However, uniquely incorporating the one or more content domains in the content may be tedious and restricted.

### SUMMARY

One aspect of the present disclosure relates to a system configured to generate narratives based on a comprehensive set of experiences of users. The system may include electronic storage, one or more hardware processors configured by machine-readable instructions, and/or other components. The electronic storage may store content domains, a content generation model, and/or other information. The content domain may include characters, style, faction, history, lineage, affiliations, descriptions, anecdotes of the content domain, and/or other content domain information. The content generation model may analyze information to identify individual adventures of individual users, and generate individual narratives for the individual adventures.

The machine-readable instructions may include one or more instruction components. The instruction components may include computer program components. The instruction components may include one or more of authorization receiving component, aspect value determination component, narrative generating component, presentation effectuation component, and/or other instruction components.

The authorization receiving component may be configured to receive user authorization to obtain, from information sources, pieces of information that define transportation and/or occurrences of a user that comprise an adventure of the user. Aspects of the transportation may include one or more transportation modes, a start point, an end point, a travel time, a class, complimentary good or services, and/or other transportation information. Aspects of the occurrences include an occurrence type, one or more of content domains, one or more companions in the occurrence, time length of the occurrence, a wait time, one or more purchases, a venue of the occurrence, and/or other occurrence information. The aspect value determination component may be configured to determine, based on the pieces of information, aspect values that define the aspects of the transportation and the aspects of the occurrences.

The narrative generating component may be configured to input the aspect values that define the aspects of the transportation and the aspects of the occurrences to the content generation model. As such, the content generation model may determine the adventure of the user and generates, based on the aspect values, a narrative that features the aspects of the occurrences and one or more aspects of the transportation to represent the adventure of the user. The narrative generating component may be configured to obtain, from the content generation model, the narrative.

The presentation effectuation component may be configured to effectuate presentation of the narrative to the user.

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured to generate narratives based on a comprehensive set of experiences of users, in accordance with one or more implementations.

FIG. 2 illustrates a method to generate narratives based on a comprehensive set of experiences of users, in accordance with one or more implementations.

FIG. 3 illustrates an example implementation of the system configured to generate narratives based on a comprehensive set of experiences of users, in accordance with one or more implementations.

### DETAILED DESCRIPTION

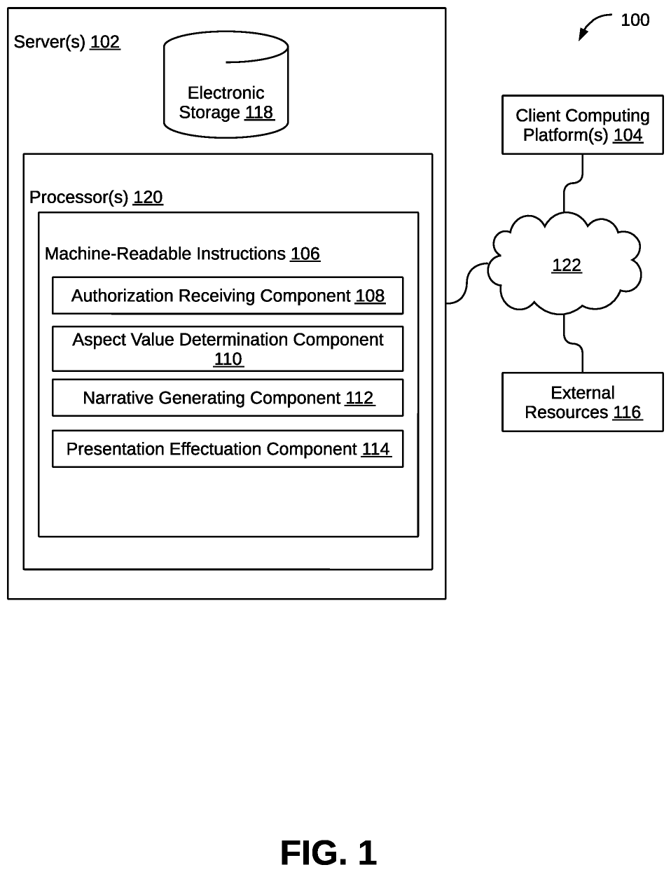

FIG. 1 illustrates a system 100 configured to generate narratives based on a comprehensive set of experiences of users, in accordance with one or more implementations. In some implementations, system 100 may include one or more servers 102. Server(s) 102 may include electronic storage 118, and may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Electronic storage 118 may store the content domains and a content generation model. The content domain may include characters, style, faction, history, lineage, affiliations, descriptions, anecdotes of the content domain, and/or other content domain information. The characters may be subjects of storylines, the lineage, and/or the anecdotes. The characters may be animated humans, humans, animals, animated animals, fictional beings, and/or other characters. The characters may include main characters, supporting characters, background characters, and/or other characters. In some implementations, the characters may be present throughout the entirety of individual ones of the storylines and the anecdotes, or part of the individual storylines and the anecdotes. The faction may specify whether individual ones of the characters or sets of the characters are part of a particular group. For example, the particular group may be villains, heroes, victims, attackers, defenders, and/or other groups. The history may include origins of the factions, origins of the characters, evolution of the factions, evolution of the characters, origins of the affiliations amongst the characters or the sets of the characters, settings of the characters (e.g., hometown, workplaces), inheritance standards (e.g., royal titles), and/or other history. The lineage may include familial history and connections amongst the characters. In some implementations, the lineage may include inherited titles that are based on the connections and the history. The affiliations may include relations between the individual characters, the individual factions, individual companies (e.g., production companies, media companies, hospitalities groups), individual locations, individual settings, and/or other affiliations. The descriptions may characterize the individual characters, the individual settings, the individual factions, the individual affiliations, and/or other content domain information. The anecdotes of the content domain may provide context for the storylines, the lineage, the affiliation, development of the characters, and/or other anecdotes.

The content generation model may be trained to analyze information to identify individual adventures of individual users. The individual adventures may refer to an amount of time, or part thereof, during which the individual users planned, took transportation, and participated in occurrences. The individual users may plan the adventures, experience the transportation, and/or experience the occurrences. In some implementations, the content generation model may identify the individual adventures of the individual users based on timestamps associated with pieces of information, image recognition, location information based on recognition devices of the users, and/or other information that comprises the adventures of the users.

The content generation model may further generate individual narratives for the individual adventures. The content generation model may employ machine learning techniques such as generative artificial intelligence, unsupervised learning, and/or other machine learning techniques to identify the adventures and generate the narratives. A narrative may summarize and/or feature various aspects of the adventures for the users. By way of non-limiting example, the narrative may include a long form video, short form video, a slideshow of photos, collection of video clips and photos, a digital or physical story book, a digital or physical photo book, a song, and/or other narratives. The long form video may transpire for a minimum amount of time. The short form video may transpire for a maximum amount of time. The slideshow of photos may include transitions between individual ones of the photos. The collection of video clips and the photos may include transitions between the individual photos and the video clips. The video clips may be videos that are a maximum amount of time (e.g., 10 seconds). The story book may include one or more of a subjects, a plot, graphic art, and/or other story book elements. The one or more subjects of the story book may include the individual users, companions that partook on the adventures, and/or other stated entities. The one or more subjects may be specified by the users. The other entities may include particular characters, fictional entities (e.g., dragons, unicorns), items (e.g., a sword), and/or other entities. The photo book may include a set of photos that are arranged on physical and/or digital pages for print and/or digital presentation. The song may include instrumental music, electronic music, singers, lyrics, and/or other song properties.

In some implementations, the content generation model may be trained to generate narrative templates. In some implementations, generation of the narrative templates may be based on the narratives previously generated for the users and one or more of the machine learning techniques. One of the narrative templates may be determined based on the information input to the content generation model (as described herein) pertaining to the adventures of the users. The narrative templates may include standardizes storylines, illustrations, photo book templates, graphics, transitions, instrumental and/or electronic music, and/or other narrative features that may be applied to generate the narratives.

Server(s) 102 may be configured by machine-readable instructions 106. Machine-readable instructions 106 may include one or more instruction components. The instruction components may include computer program components. The instruction components may include one or more of authorization receiving component 108, aspect value determination component 110, narrative generating component 112, presentation effectuation component 114, and/or other instruction components.

Authorization receiving component 108 may be configured to receive individual user authorization to obtain, from information sources, pieces of information that define transportation, occurrences, and/or other information that comprise adventures of the users. The user authorization may include input via client computing platforms 104. The input may indicate authorization to obtain all the pieces of information or particular ones of the pieces of information. In some implementations, client computing platform 104 may be associated with the user. In some implementations, client computing platform 104 may be public, associated with, and located at venues the users visited during their adventures. In some implementations, the user authorization may include recognition device information from the recognition devices, recognizable features, and/or one or more companions included in the adventures. The recognition device information may include pre-authorizations for utilization of the pieces of information, or part thereof, for generative model such as content generation model. By way of non-limiting example, the recognition devices may be in the form of a wearable (e.g., bracelet, necklace, ring) and/or other form. The recognizable features may include facial features, clothing worn, accessories worn, and/or other recognizable features. The one or more other companions may be other users, other people (e.g., children), animals (e.g., service animals), and/or other companions.

The information sources may include one or more retailers, photo services, accommodation providers, food and beverage providers, event providers, and/or other information sources. The one or more retailers may sell products such as costumes, masks, clothing, collectibles (e.g., pins), wearable accessories (e.g., hats, jewelry), and/or products. The photo services may include photographers, automated photo machines, automated video recorders, and/or other photo services. The accommodation providers may include home rental providers, hotels, hostels, cruise companies, and/or other accommodation providers. The food and beverage providers may include restaurants, portable food and beverage vendors (e.g., food and beverage carts, stadium vendors), grocery stores, convenience stores, and/or other food and beverage providers. The event providers may include stadiums, amusement parks, concert providers, television networks, movie networks, car dealerships, and/or other event providers.

In some implementations, individual ones of the pieces of information may be associated with one or more timestamps. The timestamps may include a year, a month, a day, and a time. The pieces of information may include purchase records, captured images and/or videos, scanned event admissions, reservation records, itineraries, and/or other pieces of information.

Aspects of the transportation may include one or more transportation modes, a start point, an end point, one or more travel times, a class, complimentary good or services, and/or other aspects of the transportation. The transportation modes may include motor vehicles (e.g., cars, limousine, golf carts, all-terrain vehicles, utility-terrain vehicles), motorcycles, trams, trains, aircrafts (e.g., airplanes, helicopters), carriages, watercrafts (e.g., cruise ships, ferries), and/or other transportation modes. The start point may be where the one or more transportation modes began to transport the users. The end point may be where the one or more transportation modes concludes transporting the users. The travel time may include an amount of time that the users spent in transportation. In some implementations, the travel time may be an amount of time that the users spent in transportation amongst the one or more transportation modes cumulatively. In some implementations, individual ones of the transportation modes may correspond to a travel time that specifies an amount of time that the users spent on that particular transportation mode. In some implementations, the travel times may be specific to a particular day or specific to a particular time period. The class may specify a quality of accommodations where different classes include different accommodations. By way of non-limiting example, the accommodations may include seat size, food and beverages available, leg space, luggage allowance, and/or other accommodations. By way of non-limiting example, the class may be basic, premium, economy, business, first class, or other class. The complimentary good or services may be included during the transportation such as particular foods, beverages, toiletries, Internet access, laundry, beauty treatments (e.g., manicure, pedicure, facial), wellness treatments (e.g., massage), among others.

Aspects of the occurrences may include an occurrence type, one or more of the content domains, one or more companions in the occurrence, time length of the occurrence, a wait time, one or more purchases (e.g., of consumables, merchandise), a venue of the occurrence, and/or other aspects of the occurrences.

The occurrence type may include an experience and/or an interaction. The experience type occurrences may be occurrences that the users observe. The experience type occurrences may be associated with, but are not limited to, photos taken on attractions, videos taken on the attractions, time spent waiting (e.g., in lines, before events, for food, for services), time spent at individual events, time spent at restaurants, and/or other experience occurrences. The events may include a show, a taping, a screening, an exhibit, a parade, a game (e.g., sporting game, game show), and/or other events.

The interaction type occurrences may be occurrences that the users interact with and participant in. The interaction type occurrences may include participation in the individual events, participation in the attraction, assistance received (e.g., human concierge, artificial intelligence customer service, frequently asked questions), guidance received (e.g., interactive map interfaces), and/or other interactions. In some implementations, an occurrence may be both the experience type and the interaction type.

The one or more companions in the occurrences may include one or more family members, friends, animals, and/or other companions. The wait time of the occurrence may be the amount of time the users and their companions waited for the occurrence to begin. The purchases may represent or be related to the occurrences. By way of non-limiting example, the purchases may include a souvenir, the photos and/or videos taken during the attraction, food and/or beverages related to the occurrence (e.g., a food in a specific shape or flavor), and/or other purchases.

Aspect value determination component 110 may be configured to determine based on the pieces of information, aspect values that define the aspects of the transportation, the aspects of the occurrences, and/or other aspects related to the adventures. In some implementations, the aspect values may be specified and obtained from the users themselves via client computing platforms 104 associated with the users and/or public client computing platforms 104 (e.g., kiosks). By way of non-limiting example, the users may manually enter their itinerary that specifies the transportation modes, the occurrences experienced and/or interacted with, the occurrences that will be experienced and/or interacted with, the one or more companions (e.g., spouse, children), and/or other information about their individual adventures.

Narrative generating component 112 may be configured to input the aspect values that define the aspects of the transportation, the aspects of the occurrences, and/or the other aspects related to the adventure to the content generation model. As such, the content generation model may determine the adventures of the users. Based on the aspect values, the content generation model may generate the individual narratives, as described herein, that feature the aspects of the occurrences, one or more aspects of the transportation, and/or the other aspects related to the adventures of the users. Narrative generating component 112 may be configured to obtain, from the content generation model, the individual narratives. In some implementations, the narratives obtained may be stored to electronic storage 118, a cloud storage that system 100 may communicate with, and/or other electronic storage. Such stored narratives may be utilized by the content generation model to generate the narrative templates as described herein. In some implementations, the user authorization from the users may specify where the individual narratives generated may be stored for utilized of the narrative templates and/or for machine learning techniques employed by the content generation model. In some implementations, the user authorization may specify for how long the individual narratives may be stored for utilization by the content generation model.

Presentation effectuation component 114 may be configured to effectuate presentation of the individual narratives to the users. Effectuating presentation of the narrative may include transmitting the narrative via e-mail, text messages, social media platforms, close range wireless communication, mail, and/or other presentation methods. In some implementations, subsequent to the presentation, the users may be enables to modify the narratives. Such modified narratives may be re-presented to the users (e.g., re-print and mail the photo book).

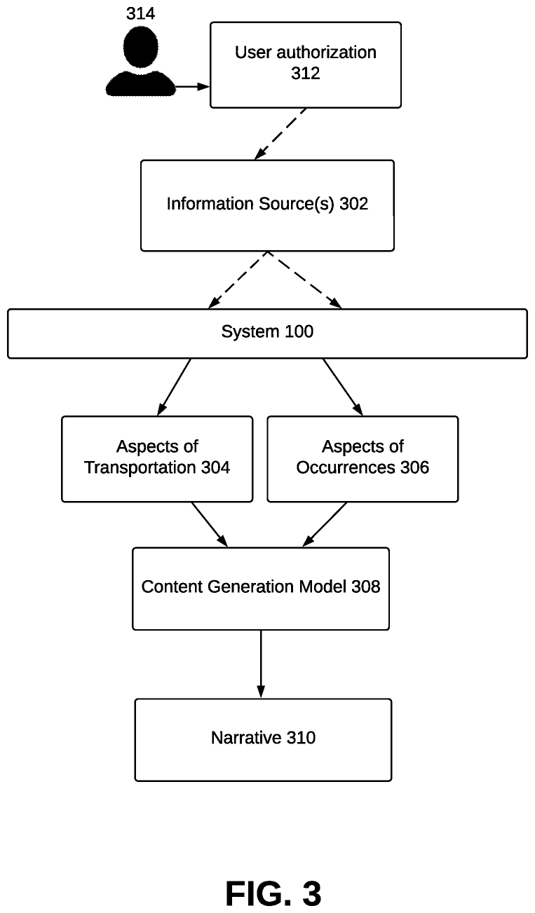

FIG. 3 illustrates a user 314 providing user authorization 312 to enable information source(s) 302 to transmit pieces of information to system 100 (described in FIG. 1) which facilitate determining aspects of transportation 304 and aspects of occurrences 306. Subsequently, aspects of transportation 304 and aspects of occurrences 306 may be provided to content generation model 308. Based on aspects of transportation 304 and aspects of occurrences 306, content generation model 308 may output a narrative 310 that features, summarized, and/or memorializes an adventure for user 314.

Referring back to FIG. 1, in some implementations, server(s) 102, client computing platform(s) 104, and/or external resources 116 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 116 may be operatively linked via some other communication media.

A given client computing platform 104 may include one or more processors configured to execute computer program components. The computer program components may be configured to enable an expert or user associated with the given client computing platform 104 to interface with system 100 and/or external resources 116, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 116 may include sources of information outside of system 100, external entities participating with system 100, and/or other resources. In some implementations, some or all of the functionality attributed herein to external resources 116 may be provided by resources included in system 100.

Server(s) 102 may include electronic storage 118, one or more processors 120, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 118 may comprise non-transitory storage media that electronically stores information. The electronic storage media of electronic storage 118 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 118 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 118 may include one or more virtual storage resources (e.g., cloud storage, a virtual private network, and/or other virtual storage resources). Electronic storage 118 may store software algorithms, information determined by processor(s) 120, information received from server(s) 102, information received from client computing platform(s) 104, and/or other information that enables server(s) 102 to function as described herein.

Processor(s) 120 may be configured to provide information processing capabilities in server(s) 102. As such, processor(s) 120 may include one or more of a digital processor, an analog processor, a digital circuit designed to process information, an analog circuit designed to process information, a state machine, and/or other mechanisms for electronically processing information. Although processor(s) 120 is shown in FIG. 1 as a single entity, this is for illustrative purposes only. In some implementations, processor(s) 120 may include a plurality of processing units. These processing units may be physically located within the same device, or processor(s) 120 may represent processing functionality of a plurality of devices operating in coordination. Processor(s) 120 may be configured to execute components 108, 110, 112, and/or 114, and/or other components. Processor(s) 120 may be configured to execute components 108, 110, 112, and/or 114, and/or other components by software; hardware; firmware; some combination of software, hardware, and/or firmware; and/or other mechanisms for configuring processing capabilities on processor(s) 120. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, and/or 114 are illustrated in FIG. 1 as being implemented within a single processing unit, in implementations in which processor(s) 120 includes multiple processing units, one or more of components 108, 110, 112, and/or 114 may be implemented remotely from the other components. The description of the functionality provided by the different components 108, 110, 112, and/or 114 described below is for illustrative purposes, and is not intended to be limiting, as any of components 108, 110, 112, and/or 114 may provide more or less functionality than is described. For example, one or more of components 108, 110, 112, and/or 114 may be eliminated, and some or all of its functionality may be provided by other ones of components 108, 110, 112, and/or 114. As another example, processor(s) 120 may be configured to execute one or more additional components that may perform some or all of the functionality attributed below to one of components 108, 110, 112, and/or 114.

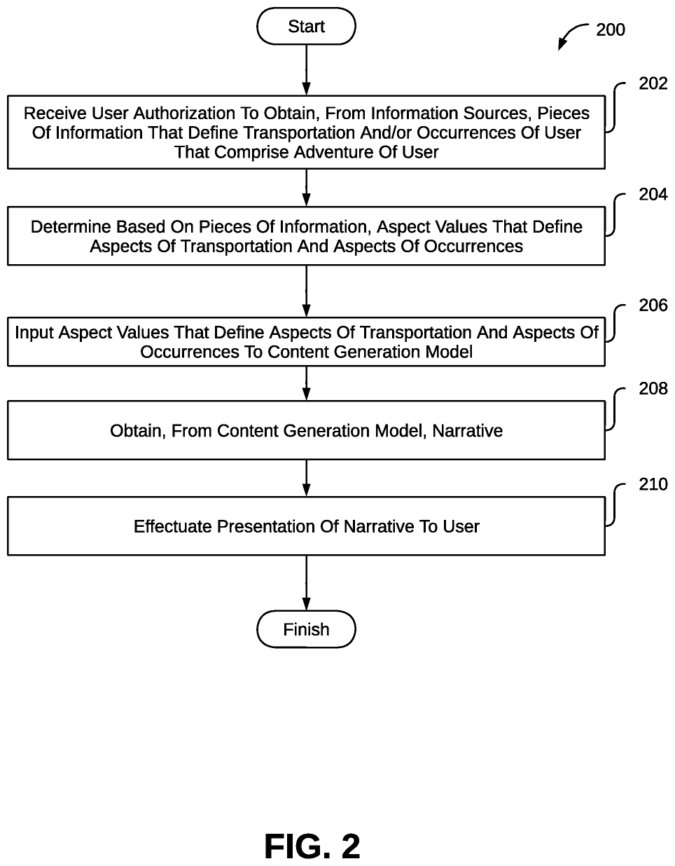

FIG. 2 illustrates a method 200 to generate narratives based on a comprehensive set of experiences of users, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include receiving user authorization to obtain, from information sources, pieces of information that define transportation and/or occurrences of a user that include an adventure of the user. Operation 202 may be performed by one or more hardware processors configured by machine-readable instructions including a component that is the same as or similar to user authorization receiving component 108, in accordance with one or more implementations.

An operation 204 may include determining, based on the pieces of information, aspect values that define the aspects of the transportation and the aspects of the occurrences. Operation 204 may be performed by one or more hardware processors configured by machine-readable instructions including a component that is the same as or similar to aspect value determination component 110, in accordance with one or more implementations.

An operation 206 may include inputting the aspect values that define the aspects of the transportation and the aspects of the occurrences to the content generation model so that the content generation model determines the adventure of the user and generates, based on the aspect values, a narrative that features the aspects of the occurrences and one or more aspects of the transportation to represent the adventure of the user. Operation 206 may be performed by one or more hardware processors configured by machine-readable instructions including a component that is the same as or similar to narrative generating component 112, in accordance with one or more implementations.

An operation 208 may include obtaining, from the content generation model, the narrative. Operation 208 may be performed by one or more hardware processors configured by machine-readable instructions including a component that is the same as or similar to narrative generating component 112, in accordance with one or more implementations.

An operation 210 may include effectuating presentation of the narrative to the user. Operation 210 may be performed by one or more hardware processors configured by machine-readable instructions including a component that is the same as or similar to presentation effectuation component 114, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to generate narratives based on a comprehensive set of experiences of users, the system comprising:
electronic storage that stores (a) content domains and (b) a content generation model, wherein a content domain includes characters, style, faction, history, lineage, affiliations, descriptions, and/or anecdotes of the content domain, wherein the content generation model (i) analyzes information to identify individual adventures of individual users, and (ii) generates individual narratives for the individual adventures;
one or more processors configured by machine-readable instructions to:
receive user authorization to obtain, from information sources, pieces of information that define transportation and/or occurrences of a user that comprise an adventure of the user, wherein:
aspects of the transportation include one or more transportation modes, a start point, an end point, a travel time, a class, and/or
complimentary good or services,
aspects of the occurrences include an occurrence type, one or more of the content domains, one or more companions in the occurrence, time length of the occurrence, a wait time, one or more purchases, and/or a venue of the occurrence;
determine, based on the pieces of information, aspect values that define the aspects of the transportation and the aspects of the occurrences;
input the aspect values that define the aspects of the transportation and the aspects of the occurrences to the content generation model so that the content generation model determines the adventure of the user and generates, based on the aspect values, a narrative that features the aspects of the occurrences and one or more aspects of the transportation to represent the adventure of the user;
obtain, from the content generation model, the narrative; and
effectuate presentation of the narrative to the user.

2. The system of claim 1, wherein the user authorization includes input via a client computing platform, wherein the input indicates authorization to obtain all the pieces of information or particular ones of the pieces of information.

3. The system of claim 1, wherein the client computing platform is associated with the user, or is associated with and located at one of the venues the user visited during the adventure.

4. The system of claim 1, wherein the user authorization includes recognition device information for recognition devices, recognizable features, and/or one or more subjects included in the adventure.

5. The system of claim 1, wherein the narrative includes a long form video, short form video, a slideshow of photos, collection of video clips and photos, a story book, and/or a photo book.

6. The system of claim 4, wherein individual ones of the pieces of information are associated with one or more timestamps, wherein the content generation model identifies the individual adventures of the individual users based on the timestamps, image recognition, and/or location information based on the recognition devices of the users.

7. The system of claim 1, wherein the information sources include one or more retailers, photo services, accommodation providers, food and beverage providers, and event providers.

8. The system of claim 1, wherein the pieces of information include purchase records, captured images and/or videos, scanned event admissions, reservation records, and/or itineraries.

9. The system of claim 1, wherein effectuating presentation of the narrative includes transmitting the narrative via e-mail, text messaging, social media platforms, and/or close range wireless communication.

10. The system of claim 1, wherein the occurrence type includes an experience and/or an interaction.

11. A method to generate narratives based on a comprehensive set of experiences of users, the method comprising:
receiving user authorization to obtain, from information sources, pieces of information that define transportation and/or occurrences of a user that comprise an adventure of the user, wherein aspects of the transportation include one or more transportation modes, a start point, an end point, a travel time, a class, and/or complimentary good or services, wherein aspects of the occurrences include an occurrence type, one or more of content domains, one or more companions in the occurrence, time length of the occurrence, a wait time, one or more purchases, and/or a venue of the occurrence, wherein electronic storage stores the content domains and a content generation model, wherein the content domain includes characters, style, faction, history, lineage, affiliations, descriptions, and/or anecdotes of the content domain, wherein the content generation model (i) analyzes information to identify individual adventures of individual users, and (ii) generates individual narratives for the individual adventures;
determining, based on the pieces of information, aspect values that define the aspects of the transportation and the aspects of the occurrences;
inputting the aspect values that define the aspects of the transportation and the aspects of the occurrences to the content generation model so that the content generation model determines the adventure of the user and generates, based on the aspect values, a narrative that features the aspects of the occurrences and one or more aspects of the transportation to represent the adventure of the user;
obtaining, from the content generation model, the narrative; and
effectuating presentation of the narrative to the user.

12. The method of claim 11, wherein the user authorization includes input via a client computing platform, wherein the input indicates authorization to obtain all the pieces of information or particular ones of the pieces of information.

13. The method of claim 11, wherein the client computing platform is associated with the user, or is associated with and located at one of the venues the user visited during the adventure.

14. The method of claim 11, wherein the user authorization includes recognition device information for recognition devices, recognizable features, and/or one or more subjects included in the adventure.

15. The method of claim 11, wherein the narrative includes a long form video, short form video, a slideshow of photos, collection of video clips and photos, a story book, and/or a photo book.

16. The method of claim 14, wherein individual ones of the pieces of information are associated with one or more timestamps, wherein the content generation model identifies the individual adventures of the individual users based on the timestamps, image recognition, and/or location information based on the recognition devices of the users.

17. The method of claim 11, wherein the information sources include one or more retailers, photo services, accommodation providers, food and beverage providers, and event providers.

18. The method of claim 11, wherein the pieces of information include purchase records, captured images and/or videos, scanned event admissions, reservation records, and/or itineraries.

19. The method of claim 11, wherein effectuating presentation of the narrative includes transmitting the narrative via e-mail, text messaging, social media platforms, and/or close range wireless communication.

20. The method of claim 11, wherein the occurrence type includes an experience and/or an interaction.
